(19) United States
(12) Patent Application Publication
(10) Pub. No.: US 2015/0199645 A1
(43) Pub. Date: Jul. 16, 2015

(54) Customer Profile View of Consolidated Customer Attributes

(71) Applicant: Bank of America Corporation, Charlotte, NC (US)

(72) Inventors: Subramanian Selvaraj Sulur, Charlotte, NC (US); Wan Lung Alvin Lee, Charlotte, NC (US); Alpesh Rajnikant Shah, Marvin, NC (US); Carl Suplee, Huntersville, NC (US)

(73) Assignee: Bank of America Corporation, Charlotte, NC (US)

(21) Appl. No.: 14/156,112

(22) Filed: Jan. 15, 2014

(51) Int. Cl. G06Q 10/10

(52) U.S. Cl. CPC G06Q 10/10

(57) ABSTRACT

According to one embodiment, a system receives a request to generate a customer profile comprising a plurality of customer attributes for a customer. The system determines a first record comprising a plurality of first record attributes associated with the customer by correlating at least one first record attribute to a customer identifier indicated by the request. A new customer profile is created in response to the request if no matched customer profile is found. The system communicates one or more of the consolidated customer attributes in response to the request.

### TECHNICAL FIELD

This invention relates generally to financial services and more specifically to providing a customer profile view of consolidated customer attributes.

### BACKGROUND

Banks, financial institutions, and other businesses use customer data for monitoring, marketing, or other similar purposes. Currently, the customer data is stored in various formats across multiple systems. Storing the customer data in multiple systems often results in data redundancies and inconsistencies. In addition, accessing the customer data from multiple sources may require using a combination of custom and ad-hoc lookup mechanisms that may be inconsistent from one source to the next.

### SUMMARY OF EXAMPLE EMBODIMENTS

In accordance with the present invention, disadvantages and problems associated with accessing customer data from multiple sources may be reduced or eliminated.

According to one embodiment of the present invention, a system receives a request to generate a customer profile comprising a plurality of customer attributes for a customer. The system determines a first record comprising a plurality of first record attributes associated with the customer by correlating at least one first record attribute to a customer identifier indicated by the request. A new customer profile is created in response to the request if no matched customer profile is found. The system communicates one or more of the consolidated customer attributes in response to the request.

Certain embodiments of the invention may provide one or more technical advantages. A technical advantage of one embodiment is reconciling a large number of customer records from multiple sources into a centralized customer repository for customers by consolidating record attributes of customer records as consolidated customer attributes of a customer profile. Providing a consolidated view of customer data in a standard presentation layer removes data inconsistencies and redundancies. Another technical advantage of an embodiment includes enriching and consolidating additional customer data into the customer profile, such as the customer's risk rating, account information, transaction data and history, and/or networks, for monitoring, marketing, or other similar purposes. Yet another technical advantage of an embodiment is communicating, as one of the consolidated customer attributes of the customer profile, a jurisdiction in which an account associated with the customer is domiciled. Providing the relevant jurisdiction of the account benefits investigative teams and/or systems if the customer is flagged for suspicious transactions.

Certain embodiments of the invention may include none, some, or all of the above technical advantages. One or more other technical advantages may be readily apparent to one skilled in the art from the figures, descriptions, and claims included herein.

### BRIEF DESCRIPTION OF THE DRAWINGS

For a more complete understanding of the present invention and for further features and advantages thereof, reference is now made to the following description taken in conjunction with the accompanying drawings, in which:

FIG. 1 illustrates an example of a system that consolidates customer data from multiple sources into a centralized customer repository for customers;

FIG. 2 illustrates an example of a customer profile stored in a database of server memory;

FIG. 3 illustrates a flowchart for communicating consolidated customer attributes to users; and

FIG. 4 illustrates a block diagram of an example system that consolidates and communicates customer data.

### DETAILED DESCRIPTION

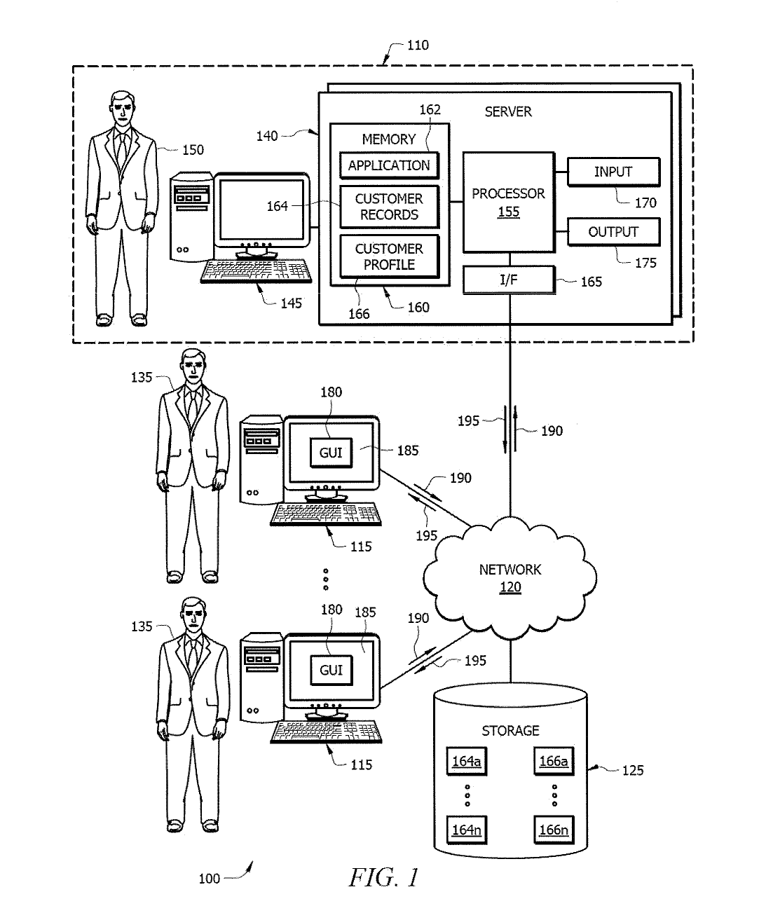

Embodiments of the present invention and its advantages are best understood by referring to FIGS. 1 through 4 of the drawings, like numerals being used for like and corresponding parts of the various drawings.

Banks, financial institutions, and other businesses use customer data for monitoring, marketing, or other similar purposes. Currently, the customer data is stored in various formats across multiple systems. Storing the customer data in multiple systems often results in data redundancies and inconsistencies. In addition, accessing the customer data from multiple sources may require using a combination of custom and ad-hoc look up mechanisms that may be inconsistent from one source to the next. The teachings of this disclosure recognize that it would be desirable to consolidate customer data from multiple sources into a centralized customer repository for customers. FIGS. 1 through 4 below illustrate a system and method of providing a consolidated view of customer data in a standard presentation layer.

FIG. 1 illustrates a system 100 according to certain embodiments. System 100 may include an enterprise 110, one or more clients 115, a network storage device 125, one or more users 135, and one or more servers 140. Enterprise 110, clients 115, and network storage device 125 may be communicatively coupled by a network 120. Enterprise 110 is generally operable to provide one or more consolidated customer attributes 195, as described below.

In general, one or more servers 140 may provide consolidated customer attributes 195 to users 135. User 135 may first provide a request 190 to generate a customer profile 166 for a customer associated with a customer identifier. Customer profile 166 may comprise any information associated with the customer that may be stored in one or more related files in one or more databases. For example, customer information may include data for the customer's personal accounts, business accounts, or both. In some embodiments, customer information may include data associated with members of the customer's household, such as the customer's spouse, children, and/or parents. Customer information in customer profile 166 may be determined from one or more customer records 164. In some embodiments, customer record 164 may refer to customer information that a particular department, line of business, or other group within enterprise 110 associates with the customer. Customer profile 166 may include customer information consolidated from multiple customer records 164. For example, a bank may maintain a customer profile 166 that includes checking account information consolidated from a first record 164a that a checking department associates with the customer and mortgage information consolidated from a second record 164b that a home loan department associates with the customer.

Thus, customer profile 166 may refer to a centralized view of a spectrum of consolidated customer attributes 195. A consolidated customer attribute 195 is a customer attribute that has been added to or updated in customer profile 166 based on a record attribute of a customer record 164. For example, a record attribute of customer record 164 may be added as a new or updated consolidated customer attribute 195 of customer profile 166. Examples of consolidated customer attributes 195 in customer profile 166 may include customer identifiers (e.g., a name, social security number, account number, driver's license number, date of birth, address, or party identifier), customer demographics (e.g., age, customer type (e.g., individual, large business, or small business), and/or one or more phone numbers, e-mail addresses, or street addresses), customer account information (e.g., account status, open date, close date, jurisdiction in which the account is domiciled, or account classifications), customer finances (e.g., personal income, fund sources, or assets), customer transactional behavior (e.g., monthly cash deposits, withdrawals, etc.), risk rating (based on financial crimes, corruption, and economic sanctions compliance information), customer networks (e.g., customer relationships, related party identifiers, household members, company affiliations, etc.), and/or instructions for party consolidation configuration (e.g., instructions for how to consolidate the customer in downstream systems).

In general, server 140 correlates customer profile 166 with customer record 164 using one or more record attributes. In some embodiments, server 140 then consolidates other record attributes of customer record 164 as one or more consolidated customer attributes 195 of customer profile 166. For example, in response to receiving request 190, server 140 may determine that request 190 indicates a customer identifier associated with the customer. Server 140 may use the customer identifier to correlate customer profile 166 with customer record 164. Examples of the customer identifier include a name, social security number, account number (e.g., a credit card account, home loan account, or checking account), driver's license number, date of birth, address, or unique party identifier (e.g., global ID across multiple accounts, like checking, savings, and loan). In some embodiments, customer identifiers may include a related party identifier associated with members of the customer's household, such as the customer's spouse, children, and/or parents.

In some embodiments, server 140 generates customer profile 166 for the customer associated with the customer identifier and determines one or more customer records 164 that one or more sources associate with the customer. Examples of sources include financial institutions, data bureaus, and/or third party vendors. Customer record 164 may comprise one or more record attributes associated with the customer. Record attributes may include customer identifiers (e.g., a name, social security number, account number, driver's license number, date of birth, address, or party identifier), customer demographics (e.g., age, customer type (e.g., individual, large business, or small business), and/or one or more phone numbers, e-mail addresses, or street addresses), customer account information (e.g., account status, open date, close date, jurisdiction in which the account is domiciled, or account classifications), customer finances (e.g., personal income, fund sources, or assets), customer transactional behavior (e.g., monthly cash deposits, withdrawals, etc.), risk rating (based on financial crimes, corruption, and economic sanctions compliance information), and/or networks (e.g., customer relationships, related party identifiers, household members, company affiliations, etc.). For example, a record attribute may be an identifier associated with members of the customer's household, such as a name or account number of the customer's spouse, children, and/or parents.

In some embodiments, server 140 may consolidate one or more record attributes of customer record 164 as one or more consolidated customer attributes 195 of customer profile 166. Consolidating record attributes can include adding attributes to customer profile 166, updating attributes and removing duplicate attributes included in customer profile 166, and/or reconciling inconsistencies in customer profile 166 (e.g., if different sources list different home addresses, consolidate the record attribute that was updated most recently).

In general, server 140 consolidates record attributes of customer record 164 as one or more consolidated customer attributes 195 and communicates one or more consolidated customer attributes 195 to user 135 utilizing client 115. Client 115 may refer to any device that enables user 135 to interact with server 140. In some embodiments, client 115 may include a computer, workstation, telephone, Internet browser, electronic notebook, Personal Digital Assistant (PDA), pager, or any other suitable device (wireless, wireline, or otherwise), component, or element capable of receiving, processing, storing, and/or communicating information with other components of system 100. Client 115 may also comprise any suitable user interface such as a display 185, microphone, keyboard, or any other appropriate terminal equipment usable by user 135. It will be understood that system 100 may comprise any number and combination of clients 115 or users 135. User 135 may utilize client 115 to interact with server 140 to receive consolidated customer attributes 195. In some embodiments, user 135 may be an employee of a financial institution analyzing customer information associated with one or more customer records 164.

In some embodiments, client 115 may include a graphical user interface (GUI) 180. GUI 180 is generally operable to tailor and filter data presented to user 135. GUI 180 may provide user 135 with an efficient and user-friendly presentation of request 190 and/or consolidated customer attributes 195. GUI 180 may comprise a plurality of displays 185 having interactive fields, pull-down lists, and buttons operated by user 135. GUI 180 may include multiple levels of abstraction including groupings and boundaries. It should be understood that the term GUI 180 may be used in the singular or in the plural to describe one or more GUIs 180 and each of the displays 185 of a particular GUI 180.

In the illustrated embodiment, network storage device 125 stores customer records 164 and customer profiles 166. Network storage device 125 may refer to any suitable device communicatively coupled to network 120 and capable of storing and facilitating retrieval of data and/or instructions. Examples of network storage device 125 include computer memory (for example, Random Access Memory (RAM) or Read Only Memory (ROM)), removable storage media (for example, a Compact Disk (CD) or a Digital Video Disk (DVD)), database and/or network storage (for example, a server), and/or any other volatile or non-volatile, non-transitory computer-readable memory devices that store one or more files, lists, tables, or other arrangements of information. Network storage device 125 may store any data and/or instructions utilized by server 140.

Clients 115, servers 140, and other components of system 100 may be communicatively coupled by network 120. In certain embodiments, network 120 may refer to any interconnecting system capable of transmitting audio, video, signals, data, messages or any combination of the preceding. Network 120 may include all or a portion of a public switched telephone network (PSTN), a public or private data network, a local area network (LAN), a metropolitan area network (MAN), a wide area network (WAN), a local, regional, or global communication or computer network such as the Internet, a wireline or wireless network, an enterprise intranet, or any other suitable communication link, including combinations thereof.

In some embodiments, enterprise 110 may refer to a financial institution such as a bank and may include one or more servers 140, an administrator workstation 145, and an administrator 150. In some embodiments, server 140 may refer to any suitable combination of hardware and/or software implemented in one or more modules to process data and provide the described functions and operations. In some embodiments, the functions and operations described herein may be performed by a pool of servers 140. In some embodiments, server 140 may include, for example, a mainframe, server, host computer, workstation, web server, file server, a personal computer such as a laptop, or any other suitable device operable to process data. In some embodiments, server 140 may execute any suitable operating system such as IBM's zSeries/Operating System (z/OS), MS-DOS, PC-DOS, MAC-OS, WINDOWS, UNIX, OpenVMS, or any other appropriate operating systems, including future operating systems.

In general, server 140 correlates one or more record attributes associated with customer record 164, consolidates the one or more attributes as one or more consolidated customer attributes 195 of customer profile 166, and then communicates one or more consolidated customer attributes 195 to users 135. In some embodiments, server 140 may include a processor 155, server memory 160, an interface 165, an input 170, and an output 175. Server memory 160 may refer to any suitable device capable of storing and facilitating retrieval of data and/or instructions. Examples of server memory 160 include computer memory (for example, RAM or ROM), mass storage media (for example, a hard disk), removable storage media (for example, a CD or a DVD), database and/or network storage (for example, a server), and/or any other volatile or non-volatile, non-transitory computer-readable memory devices that store one or more files, lists, tables, or other arrangements of information. Although FIG. 1 illustrates server memory 160 as internal to server 140, it should be understood that server memory 160 may be internal or external to server 140, depending on particular implementations. Also, server memory 160 may be separate from or integral to other memory devices to achieve any suitable arrangement of memory devices for use in system 100.

Server memory 160 is generally operable to store an application 162, customer records 164, and customer profiles 166. Application 162 generally refers to logic, rules, algorithms, code, tables, and/or other suitable instructions for performing the described functions and operations. In some embodiments, application 162 facilitates correlating one or more record attributes to the customer identifier and/or to one or more consolidated customer attributes 195, consolidating the one or more attributes as one or more consolidated customer attributes 195 of customer profile 166, and communicating consolidated customer attributes 195 to users 135.

Server memory 160 communicatively couples to processor 155. Processor 155 is generally operable to execute application 162 stored in server memory 160 to generate and communicate consolidated customer attributes 195 according to the disclosure. Processor 155 may comprise any suitable combination of hardware and software implemented in one or more modules to execute instructions and manipulate data to perform the described functions for servers 140. In some embodiments, processor 155 may include, for example, one or more computers, one or more central processing units (CPUs), one or more microprocessors, one or more applications, and/or other logic.

In some embodiments, communication interface 165 (I/F) is communicatively coupled to processor 155 and may refer to any suitable device operable to receive input for server 140, send output from server 140, perform suitable processing of the input or output or both, communicate to other devices, or any combination of the preceding. Communication interface 165 may include appropriate hardware (e.g., modem, network interface card, etc.) and software, including protocol conversion and data processing capabilities, to communicate through network 120 or another communication system, which allows server 140 to communicate to other devices. Communication interface 165 may include any suitable software operable to access data from various devices such as clients 115 and/or network storage device 125. Communication interface 165 may also include any suitable software operable to transmit data to various devices such as clients 115 and/or network storage device 125. Communication interface 165 may include one or more ports, conversion software, or both. In general, communication interface 165 receives request 190 from user 135 and transmits consolidated customer attributes 195 to client 115.

In some embodiments, input device 170 may refer to any suitable device operable to input, select, and/or manipulate various data and information. Input device 170 may include, for example, a keyboard, mouse, graphics tablet, joystick, light pen, microphone, scanner, or other suitable input device. Output device 175 may refer to any suitable device operable for displaying information to a user. Output device 175 may include, for example, a video display, a printer, a plotter, or other suitable output device.

In general, administrator 150 may interact with server 140 using administrator workstation 145. In some embodiments, administrator workstation 145 may be communicatively coupled to server 140 and may refer to any suitable computing system, workstation, personal computer such as a laptop, or any other device operable to process data. In certain embodiments, administrator 150 may utilize administrator workstation 145 to manage server 140 and any of the data stored in server memory 160 and/or network storage device 125. For example, administrator 150 may manually force consolidating customer record 164 as one or more consolidated customer attributes 195 of customer profile 166.

In operation, application 162, upon execution by processor 155, facilitates associating one or more record attributes of customer record 164 with the customer, consolidating the one or more attributes as one or more consolidated customer attributes 195 of customer profile 166, and communicating consolidated customer attributes 195 to users 135. To provide consolidated customer attributes 195, application 162 may first receive request 190 from user 135. Request 190 may indicate one or more customer identifiers indicating the customer for whom consolidated customer attributes 195 are being requested. Examples of customer identifiers include customer name, social security number, date of birth, unique party identifier (e.g., a unique identifier assigned by the enterprise to identify all the accounts associated with the customer), account number, and so on.

In some embodiments, application 162 may generate customer profile 166 for the customer associated with the customer identifier in response to request 190. Generating customer profile 166 can refer to creating a new customer profile (e.g., if no existing customer profile associated with the customer is found) or updating an existing customer profile. Customer profile 166 may comprise any information associated with the customer that may be stored in one or more customer records 164 in one or more databases. For example, customer information may include data for the customer's personal accounts, business accounts, or both. Customer information may also include data associated with members of the customer's household, such as the customer's spouse, children, and/or parents. In some embodiments, application 162 may generate a unique party identifier and associate the party identifier with customer profile 166. The party identifier may refer to a unique identifier assigned by the financial institution to identify the customer information and accounts that are to be included in customer profile 166. For example, the party identifier may be used to identify all of the accounts associated with the customer.

Once application 162 receives request 190, application 162 may determine a first customer record 164a that a first source associates with the customer, first customer record 164a comprising a first set of record attributes, by correlating at least one of the first record attributes to the customer identifier indicated in request 190. For example, if the customer identifier in request 190 is a checking account number and the first source is a checking department of a financial institution associated with the checking account, the checking account number may be used to determine that the checking department's record is associated with the customer.

In some embodiments, application 162 may consolidate one or more first record attributes as one or more consolidated customer attributes 195 of customer profile 166. For example, if a checking account record determined to be associated with the customer based on a checking account number comprises additional record attributes (e.g., a party identifier, credit card account information, and/or contact information), application 162 may consolidate the checking account information, party identifier, credit card account information, and/or contact information into customer profile 166.

In response to consolidating one or more of the first record attributes as one or more consolidated customer attributes 195, application 162 may determine a second customer record 164b that a second source associates with the customer, second customer record 164b comprising a second set of record attributes, by correlating at least one of the second record attributes to one of the consolidated customer attributes 195 that is different from the customer identifier indicated by request 190. For example, the customer identifier in request 190 may be a checking account number, the second source may be a mortgage department of a financial institution, and the mortgage department's record associated with the customer may not include the checking account number as a record attribute. While the mortgage department's record cannot be associated with the customer using the original customer identifier (checking account number from request 190), the mortgage department's record can be associated with the customer if an attribute included in the mortgage department's record identifying the customer is also a consolidated customer attribute 195 of customer profile 166. Referring to the above example, if the mortgage department's record includes the party identifier, credit card account information, and/or contact information now included in customer profile 166, the mortgage department's record can be associated with the customer by using the party identifier, credit card account information, and/or contact information. Application 162 may then consolidate one or more second record attributes of customer record 164b as one or more consolidated customer attributes 195 of customer profile 166.

In some embodiments, application 162 may use one or more consolidated customer attributes 195 to associate a related party with the customer. The related party can be the customer itself, a member of the customer's household, or another related party. In certain embodiments, application 162 may consolidate the related party as one or more consolidated customer attributes 195. Application 162 may then communicate consolidated customer attributes 195 in response to request 190.

Application 162 communicates consolidated customer attributes 195 in any suitable format. In some embodiments, consolidated customer attributes 195 can have a standardized format comprising standardized fields. For example, if a customer is an individual, the standardized fields may include a household ID. But if the customer is a business, the standardized fields would not include a household ID. Consolidated customer attributes 195 may also be communicated according to one or more categories associated with customer profile 166. For example, application 162 may determine one or more categories associated with customer profile 166, the one or more categories comprising a customer identifier category (e.g., identifiers that identify the customer associated with customer profile 166), demographic category (e.g. customer contact information, age, or type), account information category (e.g., customer to account relationships, account level information, or methods for classifying an account), network category (customer relationships such as related party identifiers, household members, or company affiliations), financial category (e.g., personal income, source of funds, or assets), risk category (associated with financial crimes, corruption, and economic sanctions compliance information), party consolidation configuration category (instructions for how to consolidate customer data in downstream systems) and/or customer transaction data category (e.g., customer transaction behavior or history). For each consolidated customer attribute 195, application 162 may consolidate the attribute in the relevant category. Moreover, consolidated customer attributes 195 may be communicated to a display or other user interface, or it can be communicated to downstream systems. For example, one or more servers 140 may provide consolidated customer attributes 195 to user 135 by utilizing client 115.

In some embodiments, application 162 may communicate a risk indicator associated with customer profile 166 to user 135 if consolidated customer attributes 195 present a potential risk. For example, application 162 may process consolidated customer attributes 195 according to a risk-determination rule to determine a risk level. If the risk level exceeds a pre-determined threshold, the risk indicator may be communicated. An example of a risk-determination rule may be to determine whether the customer has accrued a certain number of potentially suspicious transactions or irregular activities, such as cash structuring transactions or large cash deposits, or any combination thereof. Any suitable risk indicator may be used. For example, the data that caused the risk to be generated may be highlighted or a text description of the risk may be provided. In some embodiments, application 162 may communicate a risk score, such as a score based on a formula that includes consolidated customer attributes 195 as inputs, that may be used by user 135 to evaluate the risk. The score may be calculated at a line of business level, an enterprise level, and/or other suitable level. Further, the risk indicator may be associated with customer profile 166 and/or consolidated as a consolidated customer attribute 195 of customer profile 166. Application 162 may also associate the risk indicator with the risk category of customer profile 166.

In some embodiments, application 162 may communicate, as one of the consolidated customer attributes 195 of customer profile 166, a jurisdiction in which an account associated with the customer is domiciled. An advantage of this embodiment would be providing user 135 with the relevant jurisdiction for investigative teams and/or systems if the customer is flagged for suspicious transactions.

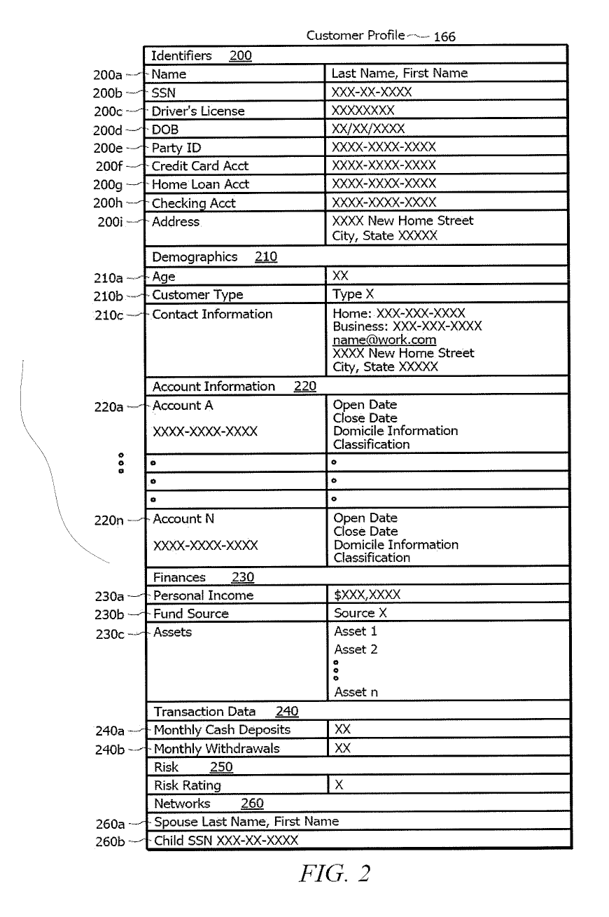

FIG. 2 illustrates an example of customer profile 166 stored in a database of server memory 160. Customer profiles 166 stored in server memory 160 may include multiple customer profiles 166, such as one or more of customer profiles 166a to 166n of network storage device 125. Customer profile 166 may also include any information associated with a customer that may be stored in one or more customer records 164 in one or more databases of server memory 160 and/or one or more of customer record 164a to 164n of network storage device 125. For example, customer information may include data for the customer's personal accounts, business accounts, or both. Customer information may also include data associated with members of the customer's household, such as the customer's spouse, children, and/or parents. Server memory 160 may store the data in any suitable format.

Customer profile 166 may refer to a centralized view of a spectrum of consolidated customer attributes 195. The one or more consolidated customer attributes 195 may include multiple record attributes of customer records 164, such as one or more record attributes of customer records 164a to 164n of network storage device 125. Examples of consolidated customer attributes 195 include one or more customer identifiers 200 (e.g., a name 200a, social security number 200b, driver's license number 200c, date of birth 200d, party identifier 200e, credit card account number 200f, home loan account number 200g, checking account number 200h, or address 200i), customer demographics 210 (e.g., age 210a, customer type 210b (e.g., individual, large business, or small business), or contact information 210c), customer account information 220 (e.g., information associated with accounts 220a to 220n indicating account status, open date, close date, jurisdiction in which the account is domiciled, account classifications, etc.), customer finances 230 (e.g., personal income 230a, fund sources 230b, assets 230c, etc.), customer transaction data 240 (e.g., monthly cash deposits 240a, withdrawals 240b, etc.), risk rating 250 (based on financial crimes, corruption, and economic sanctions compliance information), and/or networks 260 (e.g., related party identifiers such as spouse first and last name 260a, child social security number 260b, etc.).

Although certain examples have been used to illustrate customer profile 166, any suitable customer information may be used. For example, customer transaction data 240 may also include one or more transaction dates (the date a transaction occurred), transaction types (e.g., deposit, withdrawal, transfer, etc.), detailed descriptions of transactions, and/or flags for suspicious transactions (warnings for transactions such as cash structuring, high-amount cash deposits inconsistent with the customer's transaction history or income, foreign wire transactions, etc.). In some embodiments, consolidated customer attributes 195 may also include instructions for party consolidation configuration (e.g., instructions for how to consolidate the customer in downstream systems).

In some embodiments, the database stores the data in a format that allows consolidated customer attributes 195 to be presented according to one or more categories associated with customer profile 166. As an example, FIG. 2 illustrates a customer profile 166 comprising a customer identifier category 200 (e.g., identifiers that identify the customer associated with customer profile 166), demographic category 210 (general information about the customer such as contact information, age, or type), account information category 220 (e.g., relationship category indicating customer to account relationships, account level information, methods for classifying an account, etc.), financial category 230 (e.g., personal income, source of funds, or assets), transaction data category 240 (e.g., customer transaction behavior or history), risk category 250 (associated with financial crimes, corruption, and economic sanctions compliance information), and/or network category 260 (e.g., customer relationships, related party identifiers, household members, company affiliations, etc.). In some embodiments, customer profile 166 may comprise a party consolidation configuration category (e.g., instructions for how to consolidate customer data downstream). Moreover, the database may present a high-level view with hyperlinks to allow for drilling down into the details of a particular category.

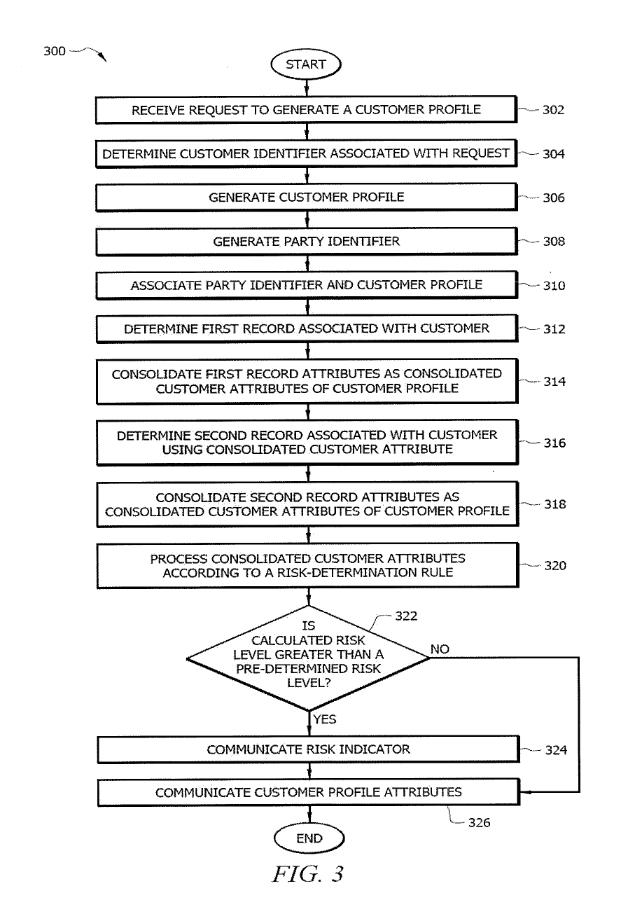

FIG. 3 illustrates a flowchart for communicating consolidated customer attributes 195 to users 135. The method begins at step 302 by receiving request 190 to generate customer profile 166 from user 135. In some embodiments, request 190 may be initiated by a user via a website, such as a password-protected or other secure website. The website prompts the user to lookup a customer using any suitable search criteria. Examples of search criteria may include name, contact information, account number, social security number, or party identifier.

At step 304, the method determines one or more customer identifiers indicated in request 190, the one or more customer identifiers identifying the customer for whom consolidated customer attributes 195 are being requested. As an example, the method may select the name, social security number, account number, driver's license number, date of birth, address, party identifier, or another criterion from request 190 as the customer identifier. Alternatively, the method may map one or more criterion from request 190 to a customer identifier, such as a unique party identifier assigned by the enterprise.

The method proceeds to step 306 to generate customer profile 166 for the customer associated with the customer identifier. Generating customer profile 166 can refer to creating a new customer profile (e.g., if no existing customer profile associated with the customer is found) or updating an existing customer profile. Customer profile 166 may comprise any information associated with the customer that may be stored in one or more customer records 164. For example, customer information may include data for the customer's personal accounts, business accounts, or both. In some embodiments, customer information may include data associated with members of the customer's household, such as the customer's spouse, children, and/or parents.

Customer information in customer profile 166 may refer to consolidated customer attributes 195. Consolidated customer attribute 195 is a customer attribute that has been added to or updated in customer profile 166 based on a record attribute of customer record 164. For example, a record attribute of customer record 164 may be added as a new or updated consolidated customer attribute 195 of customer profile 166. Examples of consolidated customer attributes 195 in customer profile 166 may include customer identifiers (e.g., a name, social security number, account number, driver's license number, date of birth, address, or party identifier), customer demographics (e.g., age, customer type (e.g., individual, large business, or small business), and/or one or more phone numbers, e-mail addresses, or street addresses), customer account information (e.g., account status, open date, close date, jurisdiction in which the account is domiciled, or account classifications), customer finances (e.g., personal income, fund sources, or assets), customer transactional behavior (e.g., monthly cash deposits, withdrawals, etc.), risk rating (based on financial crimes, corruption, and economic sanctions compliance information), customer networks (e.g., customer relationships, related party identifiers, household members, company affiliations, etc.), and/or instructions for party consolidation configuration (e.g., instructions for how to consolidate the customer in downstream systems).

In some embodiments, the method may generate a unique party identifier at step 308. The party identifier may refer to a unique identifier assigned by the financial institution to identify the customer data and accounts that are to be included in customer profile 166. For example, the party identifier may be used to identify all of the accounts associated with the customer. The method may then associate the party identifier with customer profile 166 at step 310.

At step 312, the method determines a first customer record 164a that a first source associates with the customer by correlating the customer identifier indicated in request 190 to a record attribute of first customer record 164a. For example, if the customer identifier in request 190 is a checking account number and the first source is a checking department of a financial institution associated with the checking account, the checking account number may be used to determine that the checking department's record is associated with the customer.

One or more record attributes of customer record 164 may be consolidated as one or more consolidated customer attributes 195 of customer profile 166 at step 314. Consolidating record attributes can include adding attributes to customer profile 166, updating attributes and removing duplicate attributes included in customer profile 166, and/or reconciling inconsistencies in customer profile 166 (e.g., if different sources list different home addresses, consolidate the record attribute that was updated most recently). As an example, if a checking account record determined to be associated with the customer based on a checking account number comprises additional record attributes (e.g., a party identifier, credit card account information, and/or contact information), the method may consolidate the checking account information, party identifier, credit card account information, and/or contact information in customer profile 166.

In the illustrated embodiment, the method proceeds to step 316 to determine a second customer record 164b that a second source associates with the customer by correlating one of the consolidated customer attributes 195 to a record attribute of second record 164b. The record attribute that is used to correlate second record 164b is different from the customer identifier indicated by request 190. For example, the customer identifier in request 190 may be a checking account number, the second source may be a mortgage department of a financial institution, and the mortgage department's record associated with the customer may not include the checking account number as a record attribute. While the mortgage department's record cannot be associated with the customer using the original customer identifier (checking account number from request 190), the mortgage department's record can be associated with the customer if an attribute included in the mortgage department's record identifying the customer is also a consolidated customer attribute 195 of customer profile 166. Referring to the above example, if the mortgage department's record included the party identifier, credit card account information, and/or contact information now included in customer profile 166, the mortgage department's record can be associated with the customer by using the party identifier, credit card account information, and/or contact information.

At step 318, the method may consolidate one or more second record attributes of customer record 164b as one or more consolidated customer attributes 195 of customer profile 166. For example, in addition to the above attributes of the mortgage department's record, the mortgage department's record may also comprise a mortgage account number, mortgage account information, the customer's assets and fund sources, customer type, and so on. The method may consolidate one or more of the mortgage department's additional record attributes (e.g., the mortgage account number, mortgage account information, the customer's assets and fund sources, customer type, etc.) as one or more consolidated customer attributes 195.

In some embodiments, the method may use one or more of the consolidated customer attributes 195 to associate a related party and/or related party record with the customer. The related party can be the customer itself, a member of the customer's household, or another related party. In certain embodiments, the method may consolidate the related party and/or related party record as one or more consolidated customer attributes 195.

At step 320, the method may process consolidated customer attributes 195 according to a risk-determination rule. An example of a risk-determination rule may be to determine whether the customer has accrued a certain number of potentially suspicious transactions or irregular activities, such as cash structuring transactions or large cash deposits, or any combination thereof. In some embodiments, the method may determine a risk score, such as a score based on a formula that includes consolidated customer attributes 195 as inputs, that may be used by user 135 to evaluate the risk. The score may be calculated at a line of business level, an enterprise level, and/or other suitable level.

At step 322, the method compares the calculated risk level to a pre-determined risk level. The pre-determined risk level indicates whether the risk is considered to be potentially problematic. Accordingly, if the calculated risk level is less than the pre-determined risk level, the method proceeds directly to step 326. Alternatively, if the calculated risk level is greater than or equal to the pre-determined risk level, the method associates a risk indicator with customer profile 166 and communicates the risk indicator indicating the risk level at step 324. Any suitable risk indicator may be used. For example, consolidated customer attributes 195 associated with the risk may be highlighted. As another example, a description of the risk may be generated, such as a text description or a numeric risk score. In some embodiments, the risk indicator may be consolidated as a consolidated customer attribute 195 of customer profile 166.

The method communicates one or more consolidated customer attributes 195 in response to request 190 at step 326. Consolidated customer attributes 195 may be communicated in any suitable format, including the standardized format comprised of standardized fields and/or categories described with reference to FIG. 2. For example, if a customer is an individual, the standardized fields may include a household identifier. But if the customer is a business, the standardized fields would not include a household identifier. Moreover, consolidated customer attributes 195 may be communicated to a display or other user interface, or it can be communicated to downstream systems. For example, the method may display consolidated customer attributes 195 and any risk indicators via the website that the user utilized to enter request 190.

Once the method communicates one or more consolidated customer attributes 195 at step 326, the method ends.

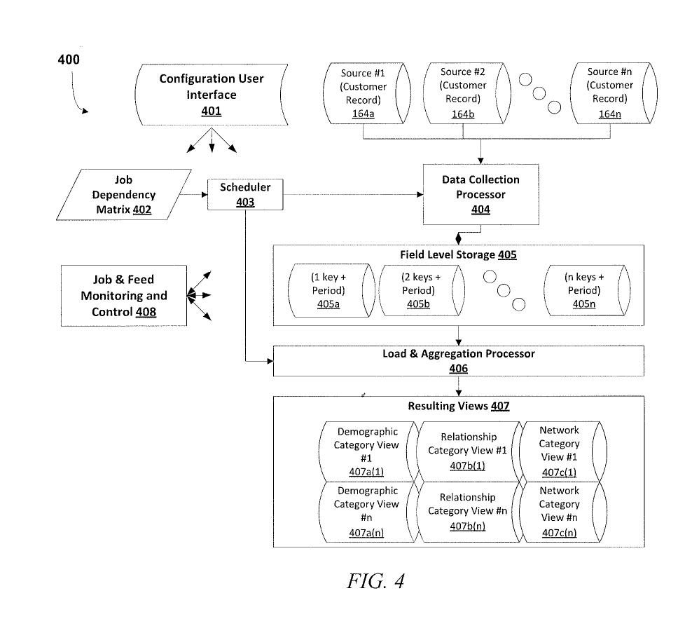

FIG. 4 illustrates a block diagram of an example system 400 according to certain embodiments. System 400 may include a user interface module 401, dependency matrix 402, scheduler module 403, collection module 404, storage module 405, aggregation module 406, profile view module 407, and control module 408. System 400 is generally operable to consolidate and communicate customer data.

In general, user interface module 401 receives a request 190 for customer information from a user 135 and/or administrator 150. Thus, user interface module 401 enables user 135 and/or administrator 150 to request and receive one or more consolidated customer attributes 195 of a customer profile 166. Consolidated customer attributes 195 may include any information associated with the customer that may be stored in one or more related files in one or more databases. In some embodiments, user interface module 401 can store and facilitate retrieval of customer data and/or instructions in response to receiving request 190. In some embodiments, configuration module 401 may receive logic, rules, algorithms, code, tables, and/or other suitable instructions for performing the described functions and operations from user 135 and/or administrator 150.

Control module 408 may be communicatively coupled to scheduler module 403, collection module 404, storage module 405, aggregation module 406, and/or profile view module 407. Control module 408 is generally operable to receive information, transmit information, perform processing of information, communicate to other devices, control the operation and administration of consolidating and communicating customer data, or any combination of the preceding. For example, control module 408 may facilitate executing a job (such as instructions to retrieve, consolidate, and/or update certain attributes) and manipulating data for correlating a customer with a customer record 164, generating a customer profile 166, and consolidating one or more record attributes of customer record 164 as one or more consolidated customer attributes 195 of customer profile 166. Control module 408 may be a programmable logic device, a microcontroller, a microprocessor, any processing device, or any combination of the preceding.

In some embodiments, dependency matrix 402 refers to any suitable set of instructions, logic, or code embodied in a computer readable storage medium for consolidating and communicating customer data according to this disclosure. Dependency matrix 402 may be operable to communicate with scheduler module 403. In certain embodiments, dependency matrix 402 receives data and/or instructions from configuration module 401, user 135, and/or administrator 150. Dependency matrix 402 may perform validation to ensure that data is ready for processing and, if a determination is made that the data is not ready, may wait to run the job until the data is ready.

Scheduler module 403 controls the operation and administration of collection module 404 and aggregation module 406 by processing information received from configuration module 401 and dependency matrix 402. For example, scheduler module 403 may control when collection module 404 retrieves and processes customer records 164 associated with a customer (e.g., instruct collection module 404 to retrieve any new customer records 164 associated with a specific customer on a weekly basis). As another example, scheduler module 403 may control when aggregation module 406 consolidates record attributes of customer records 164 as consolidated customer attributes 195 of customer profile 166 (e.g., if collection module 404 retrieves new customer records 164, instruct aggregation module 406 to add or update consolidated customer attributes 195 of customer profile 166 based on any new record attributes of new customer records 164).

Collection module 404 facilitates retrieval of customer data associated with customer records 164 from one or more sources, such as data that a particular department, line of business, or other group associates with the customer. Collection module 404 may process/transform the customer data to make the customer data useable by collection module 404 and/or downstream processes. In some embodiments, collection module 404 determines one or more customer identifiers (e.g., name, social security number, account number, driver's license number, and so on) indicated in request 190 that identifies the customer for whom consolidated customer attributes 195 are being requested. Alternatively, collection module 404 may map one or more criterion from request 190 to a customer identifier, such as a unique party identifier assigned by an enterprise.

In some embodiments, collection module 404 determines a first customer record 164a that a first source associates with the customer by correlating the customer identifier indicated in request 190 to a record attribute of first customer record 164a. For example, if the customer identifier in request 190 is a checking account number and the first source is a checking department of a financial institution associated with the checking account, the checking account number may be used to determine that the checking department's record is associated with the customer.

In general, storage module 405 stores customer data associated with customer records 164 from multiple sources. In some embodiments, storage module 405 may generate a unique party identifier for data associated with a particular customer. The party identifier may refer to a unique identifier assigned by the financial institution to identify the customer data and accounts that are associated with the particular customer. The party identifier may be associated with one or more customer records 164 associated with the particular customer and/or a customer profile 166 associated with the particular customer as described below.

Aggregation module 406 generates customer profile 166 and consolidates record attributes of customer record 164 as one or more consolidated customer attributes 195 of customer profile 166. Generating customer profile 166 may refer to creating a new customer profile or updating an existing customer profile. Customer profile 166 may include any information associated with the customer that may be stored in one or more customer records 164 that one or more sources associate with the customer. Examples of sources include financial institutions, data bureaus, and/or third party vendors. Examples of customer information include data for the customer's personal accounts, business accounts, or both. In some embodiments, customer information may also include data associated with members of the customer's household, such as the customer's spouse, children, and/or parents.

Customer profile 166 may refer to a centralized view of a spectrum of consolidated customer attributes 195 from multiple customer records 164. Consolidated customer attribute 195 is a customer attribute that has been added to or updated in customer profile 166 based on a record attribute of customer record 164. For example, a record attribute of customer record 164 may be added as a new or updated consolidated customer attribute 195 of customer profile 166. Examples of consolidated customer attributes 195 in customer profile 166 may include customer identifiers (e.g., a name, social security number, account number, driver's license number, date of birth, address, or party identifier), customer demographics (e.g., age, customer type (e.g., individual, large business, or small business), and/or one or more phone numbers, e-mail addresses, or street addresses), customer account information (e.g., account status, open date, close date, jurisdiction in which the account is domiciled, or account classifications), customer finances (e.g., personal income, fund sources, or assets), customer transactional behavior (e.g., monthly cash deposits, iv withdrawals, etc.), risk rating (based on financial crimes, corruption, and economic sanctions compliance information), customer networks (e.g., customer relationships, related party identifiers, household members, company affiliations, etc.), and/or instructions for party consolidation configuration (e.g., instructions for how to consolidate the customer in downstream systems).

In some embodiments, aggregation module 406 consolidates the one or more record attributes of customer record 164 as one or more consolidated customer attributes 195 of customer profile 166. Consolidating record attributes can include adding attributes to customer profile 166, updating attributes and removing duplicate attributes included in customer profile 166, and/or reconciling inconsistencies in customer profile 166 (e.g., if different sources list different home addresses, consolidate the record attribute that was updated most recently). As an example, if a checking account record determined to be associated with the customer based on a checking account number comprises additional record attributes (e.g., a party identifier, credit card account information, and/or contact information), aggregation module 406 may consolidate the checking account information, party identifier, credit card account information, and/or contact information in customer profile 166. In certain embodiments, scheduler module 403 may control when aggregation module 406 generates customer profile 166 and/or consolidates record attributes of customer record 164, or which record attributes aggregation module 406 consolidates as consolidated customer attributes 195 of customer profile 166.

In some embodiments, profile view module 407 communicates one or more consolidated customer attributes 195 in response to request 190. Consolidated customer attributes 195 may be communicated in any suitable format, including the standardized format comprised of standardized fields and/or categories described with reference to FIG. 2. For example, profile view module 407 may communicate consolidated customer attributes 195 according to one or more categories associated with customer profile 166. In the illustrated embodiment, profile view module 407 communicates multiple customer profiles (e.g., for Customer 1 through Customer N) according to demographic category views 407a(1)-a(n) (e.g., general information about the customers such as contact information), relationship category views 407b(1)-b(n) (e.g., indicating customer to account relationships, account level information, methods for classifying an account, etc.), and network category views 407c(1)-c(n) (e.g., customer relationships, related party identifiers, household members, company affiliations, etc.). Additionally, consolidated customer attributes 195 may be communicated to a display or other user interface, or may be communicated to downstream systems. For example, profile view module 407 can display consolidated customer attributes 195 and any risk indicators via a website that the user utilized to enter request 190.

Modifications, additions, or omissions may be made to the systems described herein without departing from the scope of the invention. The components may be integrated or separated. Moreover, the operations may be performed by more, fewer, or other components. Additionally, the operations may be performed using any suitable logic comprising software, hardware, and/or other logic. As used in this document, “each” refers to each member of a set or each member of a subset of a set.

Modifications, additions, or omissions may be made to the methods described herein without departing from the scope of the invention. For example, the steps may be combined, modified, or deleted where appropriate, and additional steps may be added. Additionally, the steps may be performed in any suitable order without departing from the scope of the present disclosure.

Although the present invention has been described with several embodiments, a myriad of changes, variations, alterations, transformations, and modifications may be suggested to one skilled in the art, and it is intended that the present invention encompass such changes, variations, alterations, transformations, and modifications as fall within the scope of the appended claims.

What is claimed is:

1. A system, comprising:
an interface operable to:
receive a request that indicates a customer identifier, the request requesting to generate a customer profile for a customer associated with the customer identifier, the customer profile comprising a plurality of customer attributes; and
one or more processors operable to:
determine a first record that a first source associates with the customer, wherein the first record comprises a plurality of first record attributes, the first record determined by correlating at least one first record attribute to the customer identifier indicated by the request;
create a new customer profile in response to the request if no matched customer profile is found;
consolidate one or more of the first record attributes as one or more consolidated customer attributes of the customer profile; and
the interface further operable to:
communicate one or more of the consolidated customer attributes in response to the request.

2. The system of claim 1, the one or more processors further operable to:
generate a unique party identifier; and
associate the unique party identifier and the customer profile.

3. The system of claim 1, the one or more processors further operable to:
determine a second record that a second source associates with the customer, wherein the second record comprises a plurality of second record attributes, the second record determined by correlating at least one of the second record attributes to one of the consolidated customer attributes that is different from the customer identifier indicated by the request; and
consolidate one or more of the second record attributes as one or more of the consolidated customer attributes.

4. The system of claim 1, wherein one of the consolidated customer attributes indicates a jurisdiction in which an account associated with the customer is domiciled.

5. The system of claim 1, wherein one of the consolidated customer attributes indicates a related party associated with the customer.

6. The system of claim 1, the one or more processors further operable to associate each consolidated customer attribute with a corresponding category of a plurality of categories associated with the customer profile, the plurality of categories comprising:
a customer identifier category;
a demographic category;
an account information category;
a network category;
a financial category;
a risk category;
a party consolidation configuration category; and
a transaction data category.

7. The system of claim 6, the one or more processors further operable to associate the risk indicator with the risk category.

8. A method, comprising:
receiving a request that indicates a customer identifier, the request requesting to generate a customer profile for a customer associated with the customer identifier, the customer profile comprising a plurality of customer attributes;
determining, by one or more processors, a first record that a first source associates with the customer, wherein the first record comprises a plurality of first record attributes, the first record determined by correlating at least one first record attribute to the customer identifier indicated by the request;
creating a new customer profile in response to the request if no matched customer profile is found;
consolidating one or more of the first record attributes as one or more consolidated customer attributes of the customer profile; and
communicating one or more of the consolidated customer attributes in response to the request.

9. The method of claim 8, further comprising:
generating a unique party identifier; and
associating the unique party identifier and the customer profile.

10. The method of claim 8, further comprising:
determining a second record that a second source associates with the customer, wherein the second record comprises a plurality of second record attributes, the second record determined by correlating at least one of the second record attributes to one of the consolidated customer attributes that is different from the customer identifier indicated by the request; and
consolidating one or more of the second record attributes as one or more of the consolidated customer attributes.

11. The method of claim 8, wherein one of the consolidated customer attributes indicates a jurisdiction in which an account associated with the customer is domiciled.

12. The method of claim 8, wherein one of the consolidated customer attributes indicates a related party associated with the customer.

13. The method of claim 8, further comprising associating each consolidated customer attribute with a corresponding category of a plurality of categories associated with the customer profile, the plurality of categories comprising:
a customer identifier category;
a demographic category;
an account information category;
a network category;
a financial category;
a risk category;
a party consolidation configuration category; and
a transaction data category.

14. The method of claim 13, further comprising associating the risk indicator with the risk category.

15. A non-transitory computer readable storage medium comprising logic, the logic, when executed by a processor, operable to:
receive a request that indicates a customer identifier, the request requesting to generate a customer profile for a customer associated with the customer identifier, the customer profile comprising a plurality of customer attributes;
determine a first record that a first source associates with the customer, wherein the first record comprises a plurality of first record attributes, the first record determined by correlating at least one first record attribute to the customer identifier indicated by the request;
create a new customer profile in response to the request if no matched customer profile is found;
consolidate one or more of the first record attributes as one or more consolidated customer attributes of the customer profile; and
communicate one or more of the consolidated customer attributes in response to the request.

16. The logic of claim 15, further operable to:
generate a unique party identifier; and
associate the unique party identifier and the customer profile.

17. The logic of claim 15, further operable to:
determine a second record that a second source associates with the customer, wherein the second record comprises a plurality of second record attributes, the second record determined by correlating at least one of the second record attributes to one of the consolidated customer attributes that is different from the customer identifier indicated by the request; and
consolidate one or more of the second record attributes as one or more of the consolidated customer attributes.

18. The logic of claim 15, wherein one of the consolidated customer attributes indicates a jurisdiction in which an account associated with the customer is domiciled.

19. The logic of claim 15, wherein one of the consolidated customer attributes indicates a related party associated with the customer.

20. The logic of claim 15, further operable to associate each consolidated customer attribute with a corresponding category of a plurality of categories associated with the customer profile, the plurality of categories comprising:
a customer identifier category;
a demographic category;
an account information category;
a network category;
a financial category;
a risk category;
a party consolidation configuration category; and
a transaction data category.
